(19) United States
(12) Patent Application Publication
(10) Pub. No.: US 2019/0147471 A1
(43) Pub. Date: May 16, 2019

(54) EXCHANGING CONSUMPTION OF ADVERTISEMENTS FOR ACCESS TO DIGITAL MEDIA DECOUPLED IN TIME, VALUE, AND LOCATION

(71) Applicant: Invisibly, Inc., Clayton, MO (US)

(72) Inventors: James Morgan McKelvey, JR., Clayton, MO (US); Faaiz Khan, Clayton, MO (US); Daniel Lohman, St. Louis, MO (US); Shekhar Yadev, Redwood City, CA (US); Michael Orlowski, Clayton, MO (US); James Pitkow, San Francisco, CA (US)

(21) Appl. No.: 16/159,421

(22) Filed: Oct. 12, 2018

Related U.S. Application Data
(60) Provisional application No. 62/584,416, filed on Nov. 10, 2017.

(51) Int. Cl. G06Q 30/02; H04L 9/06; H04W 4/021

(52) U.S. Cl. CPC G06Q 30/0207; G06Q 30/0261; G06Q 30/0255; G06F 16/1805; H04W 4/021; H04L 2209/38; H04L 9/0643

(57) ABSTRACT

A system for providing account compensation includes an interface and a processor. The interface is configured to receive a set of activity events associated with a user. The processor is configured to: determine a user compensation event from the set of activity events; determine a stakeholder associated with the user compensation event; determine an attention level associated with the user compensation event; determine a value for the user compensation event based at least in part on the stakeholder and the attention level; and provide an indication to compensate an account associated with the user by a compensation amount corresponding to the value.

### CROSS REFERENCE TO OTHER APPLICATIONS

This application claims priority to U.S. Provisional Patent Application No. 62/584,416 entitled METHOD FOR EXCHANGING CONSUMPTION OF ONLINE ADVERTISEMENTS FOR ACCESS TO DIGITAL MEDIA DECOUPLED IN TIME, VALUE, AND LOCATION filed Nov. 10, 2017 which is incorporated herein by reference for all purposes.

### BACKGROUND OF THE INVENTION

Brand holders wish to promote their brand and propagate a desired message to consumers. This has led to a widespread use of advertising as a mechanism for putting the desired message to consumers. However, the brand holder has no assurance that the desired message is actually paid attention to by a consumer and more specifically a desired user.

### BRIEF DESCRIPTION OF THE DRAWINGS

Various embodiments of the invention are disclosed in the following detailed description and the accompanying drawings.

FIG. 1 is a block diagram illustrating an embodiment of a network system.

FIG. 2A is a block diagram illustrating an embodiment of an account compensation system.

FIG. 2B is a block diagram illustrating an embodiment of a user account data.

FIG. 2C is a block diagram illustrating an embodiment of a hierarchical organization for aggregation.

FIG. 3 is a diagram illustrating an embodiment of interactions for content access.

FIG. 4 is a diagram illustrating an embodiment of interactions for content access.

FIG. 5A is a flow diagram illustrating an embodiment of a process for providing account compensation.

FIG. 5B is a flow diagram illustrating an embodiment of a process for storing a transaction in an account.

FIG. 5C is a flow diagram illustrating an embodiment of a process for reading a transaction in an account.

FIG. 6 is a flow diagram illustrating an embodiment of a process for determining an attention level associated with a user compensation event.

FIG. 7 is a flow diagram illustrating an embodiment of a process for determining a value for a user compensation event.

FIG. 8 is a flow diagram illustrating an embodiment of a process for accessing content.

FIG. 9 is a flow diagram illustrating an embodiment of a process for increasing the account balance via a user compensation event.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A system for providing account compensation comprises an interface configured to receive a set of activity events associated with a user, and a processor configured to determine a user compensation event from the set of activity events, determine a stakeholder associated with the user compensation event, determine an attention level associated with the user compensation event, determine a value for the user compensation event based at least in part on the stakeholder and the attention level, and provide an indication to compensate an account associated with the user by a compensation amount corresponding to the value. In some embodiments, the system for providing account compensation comprises a memory coupled to the processor and configured to provide the processor with instructions.

A system for providing account compensation comprises a system for compensating and debiting a user account balance. The user account balance is accessible by a user across time (e.g., credit received by the user can be accessed at a later time) and devices (e.g., credit received by the user for actions taken using a first device can be accessed by the user using a second device). A user account is compensated in response to user compensation events—for instance, watching an online advertisement, taking an online survey, providing personal information, providing payment, providing confirmation that they are watching a movie or television program (e.g., via imaging a QR code), providing confirmation that they are viewing a print advertisement or an advertisement on a vehicle (e.g., via imaging a QR code), providing confirmation that they are entering a retail store (e.g., via imaging a QR code or providing global positioning system (e.g., GPS) data indicating the user entering a geofence region), etc. At a predetermined interval, the system for providing account compensation receives a set of activity events associated with a user. For example, the system for providing account compensation receives a set of activity events associated with a user once per 10 minutes, once per hour, once per day, etc. The system for providing account compensation analyzes the set of activity events associated with the user to determine a user compensation event. When a user compensation event is identified, a stakeholder and an attention level associated with the user compensation event are determined. The stakeholder comprises the entity providing the funds for the account compensation (e.g., the advertising content provider). The attention level comprises an indication of user attention provided during the user compensation event—for instance, the fraction of the advertisement watched, the fraction of the survey completed, time spent within a geofence region, etc. The attention level additionally comprises a factor related to user fatigue—for example, the user's ability to provide attention drops as the user watches more advertising, the user's ability to provide attention changes throughout the day, etc. A value for the user compensation event is then determined based at least in part on the stakeholder and the attention level. For example, a stakeholder provides stakeholder compensation data indicating the rates they are willing to pay for user compensation events at different attention levels, and the value is determined by querying the stakeholder compensation data for the stakeholder using the attention level. The system then provides an indication to compensate an account associated with the user by a compensation amount corresponding to the value. The user performs user compensation events throughout the day and is compensated for the events at the regular interval according to this process. An account balance is created that can be used for accessing content.

When the user attempts to access content, a request to access the content is provided to the system for providing account compensation. The system determines an access amount required to access the digital content. For example, the access amount required to access the digital content is based at least in part on an amount charged for the digital content by a content provider. The system requests a user account balance (e.g., from a user account balance storage or a system for maintaining a user account balance) and receives the user account balance. The system then determines whether the user account balance is above the access amount (e.g., whether the user has the funds to pay to access the content). In response to a positive determination that the user account balance is above the access amount, the system provides an indication to deduct the access amount from the account balance, and provides access to the digital content to the user. In response to a negative indication that the user account balance is not about the access amount, the system prompts the user to perform another action to increase the account balance. For example, the system prompts the user to view an advertisement, complete a survey, provide payment, etc. The user may have a choice of actions to perform to increase the account balance. Once the user has performed enough actions to increase the account balance above the access amount, the access amount is deducted from the account balance and access is provided to the content.

In various embodiments, the user account updates (e.g., increases to balance or decreases to balance) are stored using a ledger system, a distributed ledger system, a blockchain system, an atomic consistent isolated and durable (ACID) ledger system, or any other appropriate account storage system.

In some embodiments, the storage system for storing user account updates comprises an aggregating system and a blockchain system. A block chain system is limited in the speed at which it can store blocks. In order to accommodate high volumes of transactions such as for storing changes to attention level account balances, attention transactions are first pooled (e.g., by user up to a specified amount; by a number of transactions (e.g., 50 transactions); by a segment of users, subscribers, or non-subscribers; by content viewing; by premium content viewing; by location of user; etc.) and then the pooled transactions are stored in a blockchain. In some embodiments, the system aggregates using a hierarchy so that transactions from multiple sources are aggregated according to the hierarchy. In some embodiments, the hierarchical tree(s) have secure connections so that only trusted paths are traveled by the data to/from an account data storage. In some embodiments, the aggregation is by location (e.g., a geographical region) and the users near to the location and in some cases multiple locations are then further aggregated together. In some embodiments, there are several levels of aggregations. In some embodiments, the aggregations are not by location but are by any other grouping. In some embodiments, the transactions that are grouped are tracked or indexed in a local index or a global index, where the index identifies the group the transaction was stored in and where in the account storage (e.g., the block number or storage location) the transaction or the aggregation of transaction is stored. In some embodiments, the transaction data is stored locally in a local storage prior to being entered in a ledger (e.g., a block chain ledger). In some embodiments, the index also stores an indicator that records whether the transaction data is locally stored, is ledger stored, or any other appropriate stored status. In some embodiments, a copy of the index is stored in the ledger (e.g., a block chain ledger).

The system for providing account compensation improves a computer for providing content by removing a limitation to couple access to the content with simultaneous viewing of advertising. Decoupling access to content and viewing of advertising enables the creation of an online content marketplace. When viewing content and viewing advertising are directly connected, a user is forced to watch advertising when they want to watch content, reducing the amount of attention they are willing to pay to the advertising. A user additionally may become dissatisfied with the available advertising and cease viewing the content entirely as there are no other options for compensating the content provider. However, enabling the exchange of viewing advertising for content access or another attention activity (e.g., taking a survey, participating in a game, traveling to a target location, etc.) decouples the desired behavior (e.g., paying attention to an advertisement, brand promotion, etc.) from access to content (e.g., access to media, print publication, video, etc.) and enables an exchange mechanism for brand holders to promote brand awareness directly with consumers of content. This improves a consumer's experience and access capabilities on computer platforms.

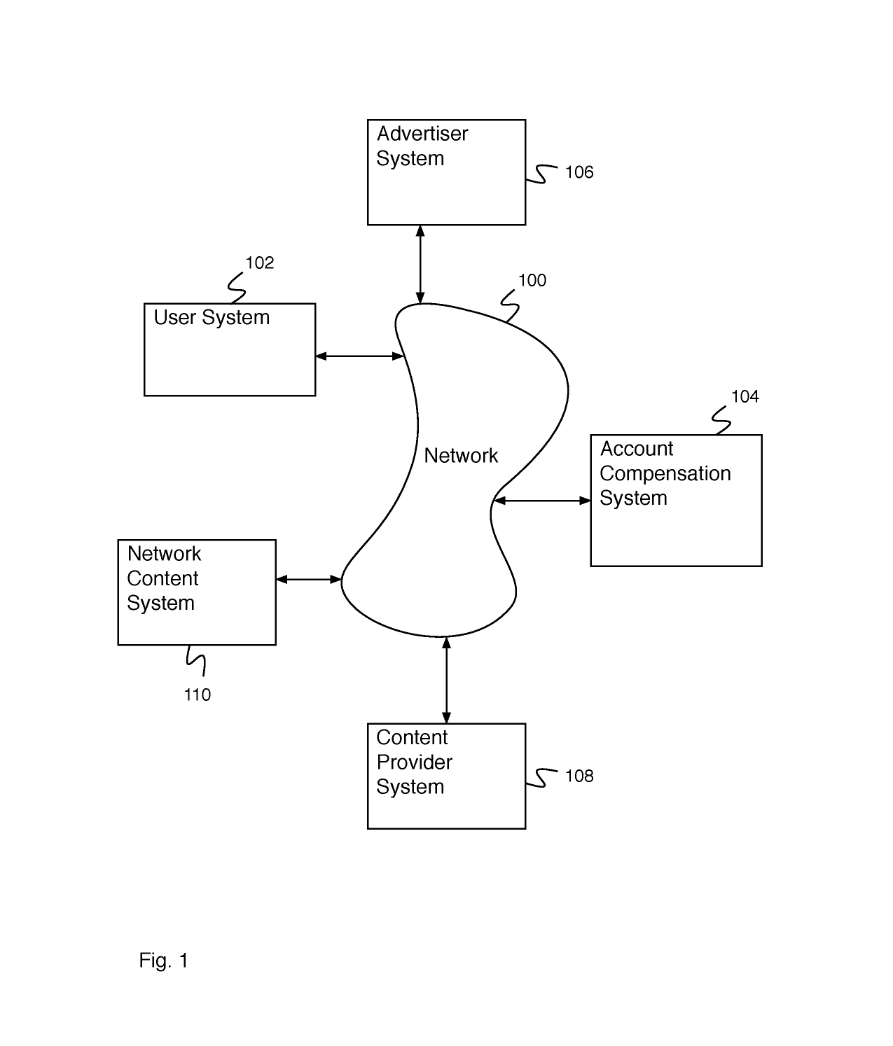

FIG. 1 is a block diagram illustrating an embodiment of a network system. In some embodiments, the network system of FIG. 1 comprises a network system for a system for providing account compensation. In the example shown, FIG. 1 comprises network 100. In various embodiments, network 100 comprises one or more of the following: a local area network, a wide area network, a wired network, a wireless network, the Internet, an intranet, a storage area network, or any other appropriate communication network. User system 102, account compensation system 104, advertiser system 106, content provider system 108, and network content system 110 communicate via network 100.

User system 102 comprises a user system for use by a user. A user uses a user system 102 to interact with content via network 100—for example to browse the web, view content, provide information, etc. User system 102 interacts with network content system 110 to browse content, search content, view content, rate content, comment on content, etc. For example, network content system comprises a web portal, a content aggregator, a content provider, etc. Content comprises images, videos, games, text, interactive experiences, etc. Content provided to user system 102 by network content system 110 is created by content provider system 108. For example, content provided by content provider system 108 comprises news content, blog content, image content, webpage content, video content, games content, digital goods content, or content with a publisher. In some embodiments, content provided to user system 102 by network content system 110 is created by a plurality of content provider systems. Content provider system 108 comprises a system for providing content. For example, content provider 108 comprises a content producer, a content creator, a content distributor, etc. Content provider system 108 provides content to one or more network content systems for distribution. In some embodiments, user system 102 interacts directly with content provider system 108 to access content. Advertiser system 106 comprises an advertiser system for providing advertisements. For example, advertiser system 106 provides advertisements to network content system 110. When a user using user system 102 views an advertisement provided by advertiser system 106, a payment associated with user system 102 is generated. Content provider system 108 requires payment for providing content to user system 102. In various embodiments, payment for providing content to user system 102 is provided to content provider system 108 by user system 102, account compensation system 104, advertiser system 106, or network content system 110. For example, user system 102 provides payment directly to content provider 108 for providing content, or user system 102 accesses an advertisement provided by advertiser system 106, and advertiser system 106 provides a payment to content provider system 108 for providing content.

Account compensation system 104 comprises a system for creating, compensating, and debiting user accounts. Network content system 110 communicates with account compensation system 104 to access content from content provider system 108 and advertising from advertiser system 106. When a user using user system 102 views an advertisement from advertiser system 106 via network content system 110, account compensation system 104 indicates to compensate an account associated with user system 102 by an amount based on the advertisement and on an attention level (e.g., how much of the advertisement was viewed by the user). Account compensation 104 receives payment from advertiser system 106. When a user using user system 102 attempts to view content from content provider system 108 via network content system 110, account compensation system 104 verifies the account associated with user system 102 contains enough credit to view the content, debits the user account by the amount of credit necessary to view the content, and provides an indication to network content system 110 to provide access to the content. Account compensation system 104 decouples the compensation and debit steps associated with viewing advertising and content, allowing the viewing of advertising and access to content to be decoupled in time (e.g., advertising could be viewed in the morning and content in the evening or the following day) or device (e.g., a user could have access to multiple devices (e.g., a smartphone, a tablet, and a computer), and access advertising and content associated with a single account using all devices).

In addition, other modes of account compensation are possible. For example, a user can provide payment to account compensation system 104 directly, a user can provide personal information to account compensation system 104, or a user can answer questions in a survey provided by account compensation system 104. A user can install an app (for instance, an app provided by account compensation system 104) on user system 102 to register user actions associated with account compensation. For example, a user can verify viewing of an offline advertisement by imaging a QR code (e.g., in printed advertising, on a vehicle, on television, during a movie, etc.) using user system 102, or a user can verify entering a shopping center or a retail store (e.g., a geographic area indicated by a geofenced region) using user system 102. Account compensation system 104 makes agreements with a set of advertisers defining a set of account compensation events for which account compensation system 104 compensates a user account.

Account compensation system 104 comprises an interface for receiving a set of activity events associated with a user (e.g., activity events from network content system 110 or user system 102 representing user actions for interacting with advertising or content). Account compensation system 104 additionally comprises a processor for determining a user compensation event (e.g., an event for which a user account should be compensated) from the set of activity events. The processor determines a stakeholder (e.g., a system providing payment to account compensation system 104—for example, advertiser system 106) associated with the user compensation event and an attention level (e.g., a metric of how much attention the user paid during the user compensation event) associated with the user compensation event. For example, a stakeholder comprises a brand owner or an advertiser. The processor then determines a value for the user compensation event based at least in part on the stakeholder and the attention level, and provides an indication to compensate an account associated with the user by a compensation amount corresponding to the value.

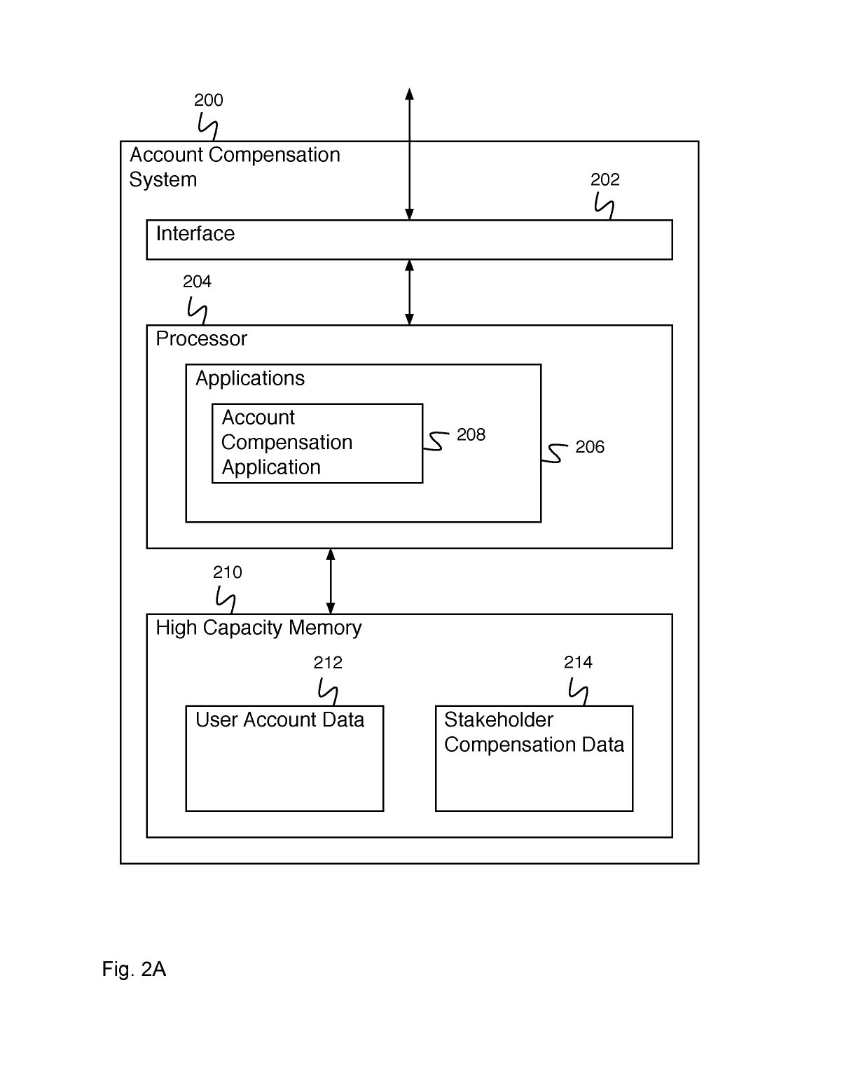

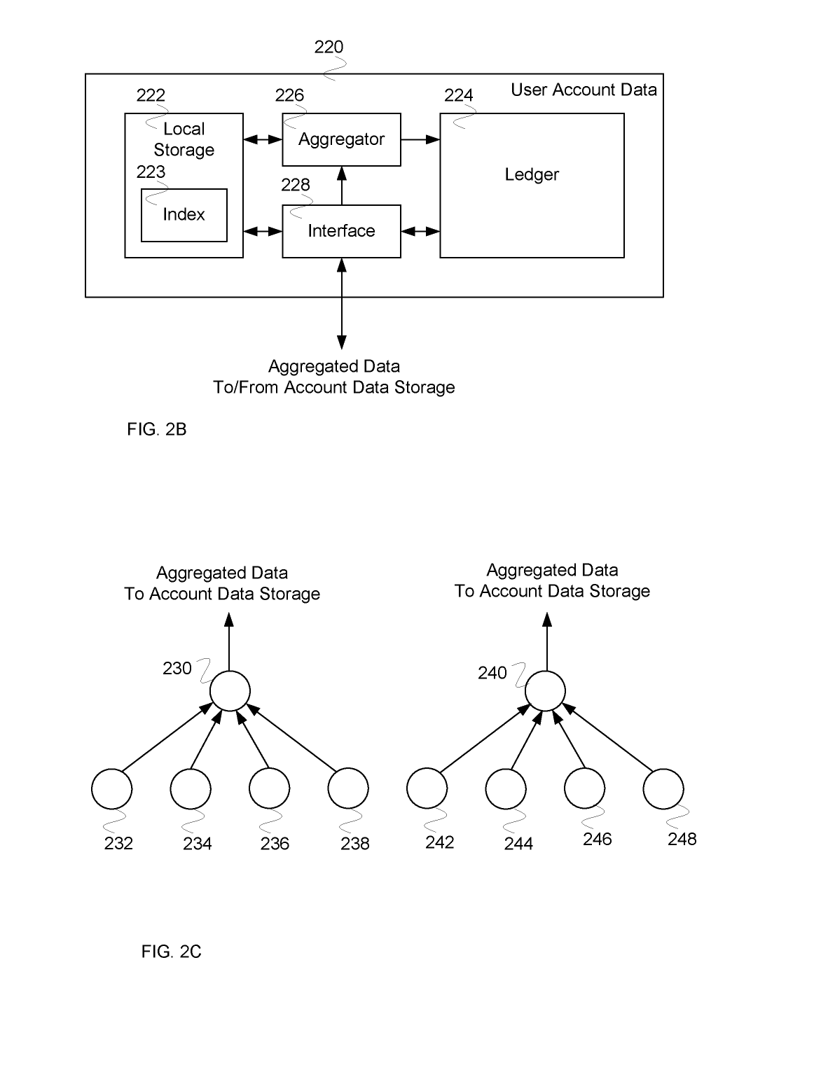

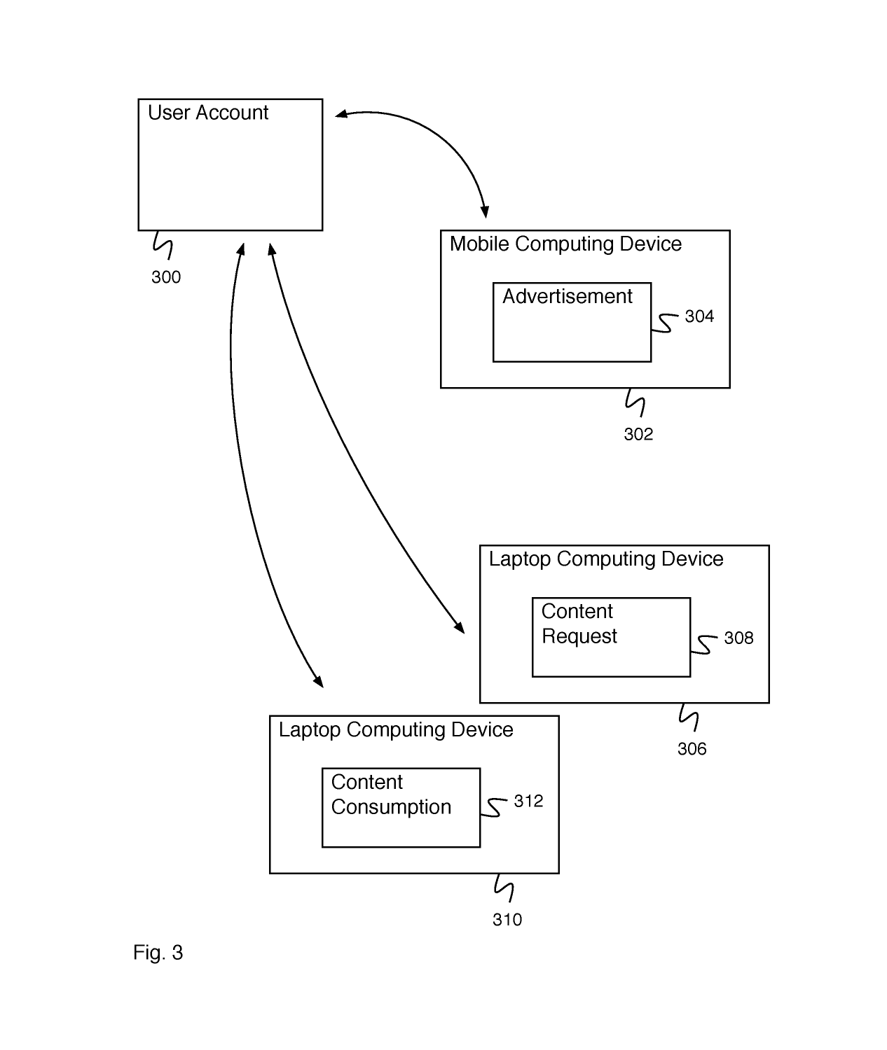

FIG. 2A is a block diagram illustrating an embodiment of an account compensation system. In some embodiments, account compensation system 200 comprises account compensation system 104 of FIG. 1. In the example shown, application server 200 includes interface 202 for communicating with external systems using a network. For example, interface 202 comprises an interface for communication with a user system, with an advertiser system, with a content provider system, with a network content system, etc. Interface 202 additionally comprises an interface for receiving a set of activity events. In some embodiments, activity events associated with a user are received at a predetermined interval (e.g., once a minute, once an hour, once a day, etc.). Processor 204 comprises a processor for executing applications. Processor 204 comprises applications 206. For example, applications 206 comprises a communications application, an application for interacting with an account, an application for interacting with an advertiser system, an application for interacting with a content provider system, an application for interacting with a network content system, etc. Applications 206 comprises account compensation application 208. Account compensation application 208 comprises an application for compensating an account. For example, account compensation application 208 comprises an application configured to determine a user compensation event from the set of activity events, determine a stakeholder associated with the user compensation event, determine an attention level associated with the user compensation event, determine a value for the user compensation event based at least in part on the stakeholder and the attention level, and provide an indication to compensate an account associated with the user by a compensation amount corresponding to the value.

High capacity memory 210 comprises a high capacity memory (e.g., a hard drive, a flash drive, etc.) for storing data. High capacity memory 210 comprises user account data 212 and stakeholder compensation data 214. User account data 212 comprises account data associated with a user—for example, account balance, user history, user information, user associated devices, behavior predictions for the user, etc. Stakeholder compensation data 214 comprises data indicating stakeholder compensation amounts. For example, stakeholder compensation data 214 comprises stakeholder compensation amounts for different activity events (e.g., for different advertisements or for different types of activity events) and/or stakeholder compensation amounts at different attention levels (e.g., how much compensation should be provided for watching half an advertisement, how much compensation should be provided for watching all of an advertisement, etc.).

FIG. 2B is a block diagram illustrating an embodiment of a user account data. In some embodiments, user account data 220 is used to implement user account data 212 of FIG. 2A. In the example shown, user account data 220 includes interface 228 for receiving aggregated data and index data for associated transactions that are part of the aggregated data. The index data is stored locally in index 223 of local storage 222. Aggregated data is also stored in local storage 222 temporarily before storing in ledger 224. In some embodiments, ledger 224 uses a block chain to store data (e.g., aggregated transaction data). In some embodiments, received aggregated data is further aggregated using aggregator 226 (e.g., data received and stored in local storage 222 is further aggregated by aggregator 226 before storing in ledger 224). In some embodiments, in the event that data is further aggregated before storage in ledger 224 index data is further updated in index 223 such that transaction data is locatable in ledger 224 even though stored as an aggregated unit. Interface 228 is also able to receive an indication to retrieve data stored in ledger 224. The indication information is used to look in index 223 to identify appropriate location within ledger 224 for retrieve data associated with the indication to retrieve data. The location information is used to retrieve data and the appropriate portions of data are extracted from the retrieved unit of data read from ledger 224. The appropriate portion is provided via interface 228 to the requestor.

FIG. 2C is a block diagram illustrating an embodiment of a hierarchical organization for aggregation. In some embodiments, the hierarchical organization of FIG. 2C is used to aggregate data for storage in user account data 220 of FIG. 2B. In the example shown, node 232, node 234, node 236, and node 238 are shown to feed data to node 230. Node 242, node 244, node 246, and node 248 are shown to feed data to node 240. In various embodiments, each node represents a location, a transaction, a user, a server, or any other appropriate unit that is aggregated.

FIG. 3 is a diagram illustrating an embodiment of interactions for content access. In some embodiments, the diagram of FIG. 3 illustrates an embodiment of interactions between user systems and an account compensation system (e.g., account compensation system 104 of FIG. 1). In the example shown, user account 300 comprises a user account stored by an account compensation system. Mobile computing device 302 (e.g., a smartphone) is associated with user account 300 (e.g., using a unique user identifier). A user uses mobile computing device 302 to view advertisement 304 (e.g., as provided by an advertiser system). For example, advertisement 304 is associated with a stakeholder and has an associated stakeholder compensation according to an attention level. Once the user uses mobile computing device 302 to view advertisement 304, user account 300 is compensated accordingly (e.g., by the account compensation system). For example, the account compensation system determines that viewing the advertisement comprises a user compensation event (e.g., from a set of activity events), determines a stakeholder associated with the user compensation event, determines an attention level associated with the user compensation event, determines a value for the user compensation event based at least in part on the stakeholder and the attention level, and provides an indication to compensate user account 300 by a compensation amount corresponding to the value. At a later time, the user uses laptop computing device 306. Laptop computing device 306 is also associated with user account 300 (e.g., via a user unique identifier). The user uses laptop computing device 306 to perform content request 308 (e.g., from a content provider system). For example, content request 308 comprises a content request to view a movie, view a television program, play a game, view images, etc. In response to the content request, the account compensation system determines an access amount necessary to access the content, determines whether user account 300 is above the access amount required to access the content, and in response to a positive indication that user account 300 is above the access amount required to access the content, debits user account 300 by the access amount and provides access to the digital content to the user (e.g., by providing an access token enabling access or unlocking of content—for example, the token can be provided to from user account 300 to a content provider system directly or indirectly via laptop computing device 310 to access content). In the example shown, a positive indication that user account 300 is above the access amount required to access the content is determined. Laptop computing device 310 comprises laptop computing device 306 after access to the digital content has been provided to the user. Laptop computing device 310 is used for content consumption 312.

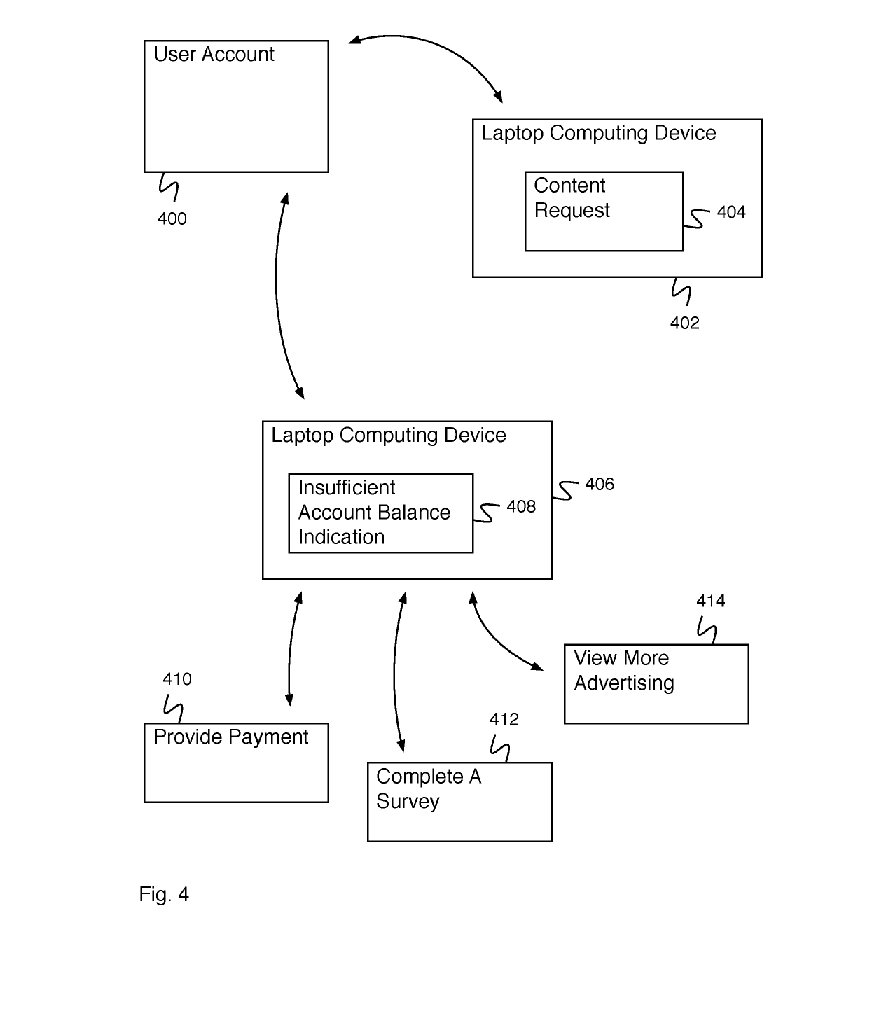

FIG. 4 is a diagram illustrating an embodiment of interactions for content access. In some embodiments, the diagram of FIG. 4 illustrates an embodiment of interactions between user systems and an account compensation system (e.g., account compensation system 104 of FIG. 1). In the example shown, user account 400 comprises a user account stored by an account compensation system. Laptop computing device 402 is associated with user account 400. The user uses laptop computing device 402 to perform content request 404. For example, content request 308 comprises a content request to view a movie, view a television program, play a game, view images, etc. In the example shown, a negative indication that user account 400 is not above the access amount required to access the content is determined. Laptop computing device 406 comprises laptop computing device 402 after the negative indication that user account 400 is not above the access amount required to access the content is determined. Laptop computing device 406 comprises insufficient account balance indication 408 indicating that access to the content is not provided. Insufficient account balance indication 408 additionally comprises prompts to one or more account compensation events available to the user to increase the account balance. For example, insufficient account balance indication comprises a prompt to using a provide payment 410 action, a complete a survey 412 action, and a view more advertising 414 action. Each account compensation action gives the user the opportunity to increase the balance in user account 400 to gain access to the requested content. For example, the action associated with view more advertising 414 includes providing a request to an advertising system to view advertisement(s), receipt of advertisements to view, and providing user account 400 system a verification of viewing or attention paid to the advertisement(s), which causes an increase in a user account. Similarly, the action associated with complete a survey 412 includes providing a request to an advertising or survey or account system to take a survey, receipt of survey to view, providing the providing system survey responses, and providing user account 400 system a verification of completion or attention paid to the survey, which causes an increase in a user account. Payment, in some cases, can be provided to user account 400 system using a payment mechanism that provides an indication to make a payment, receipt of request for payment type, amount type, etc., providing payment type, amount type, etc., causing payment transaction to complete, and causing an increase in a user account.

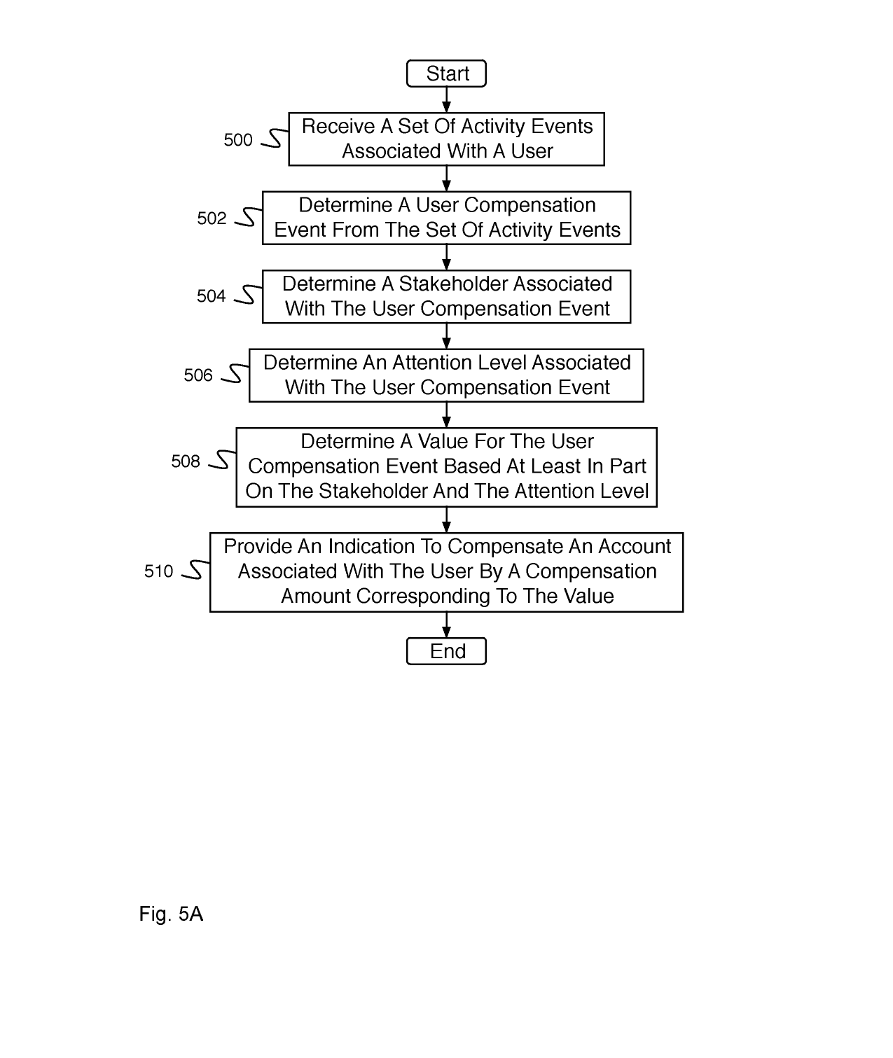

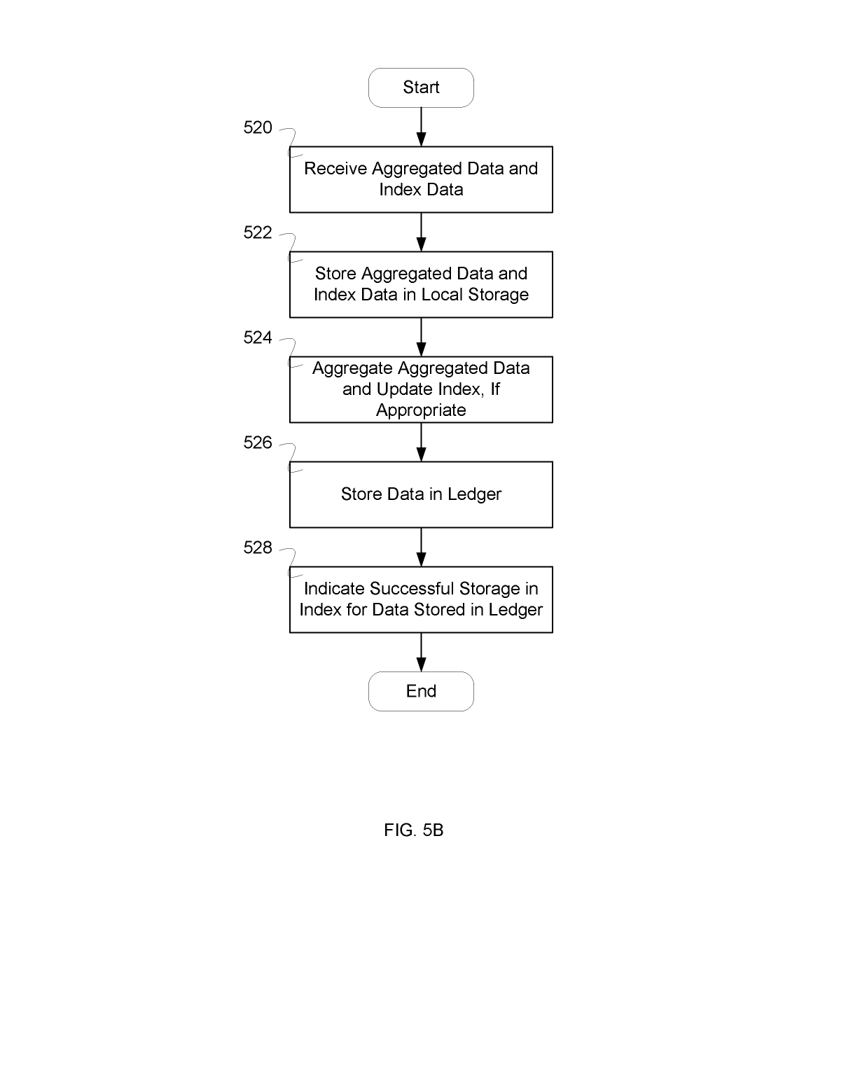

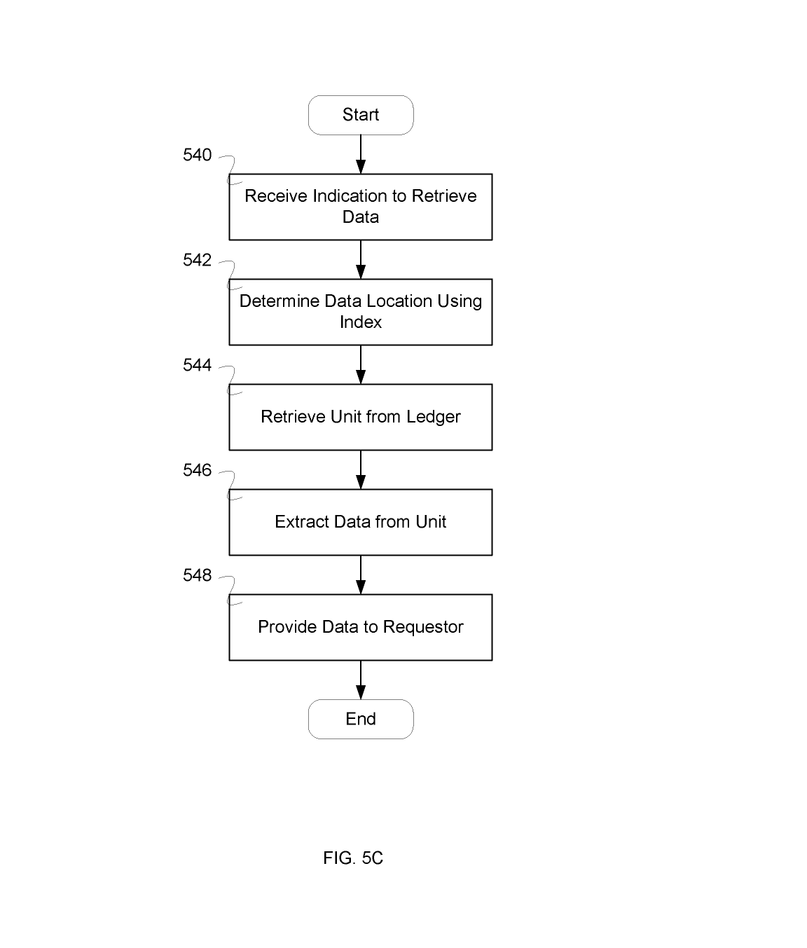

FIG. 5A is a flow diagram illustrating an embodiment of a process for providing account compensation. In some embodiments, the process of FIG. 5A is executed by account compensation system 104 of FIG. 1. In the example shown, in 500, a set of activity events associated with the user is determined. In 502, a user compensation event is determined from the set of activity events. In 504, a stakeholder associated with the user compensation event is determined. In 506, an attention level associated with the user compensation event is determined. In 508, a value for the user compensation event is determined based at least in part on the stakeholder and the attention level. In 510, an indication is provided to compensate an account associated with the user by a compensation amount corresponding to the value. For example, user account data is compensated, an indication is provided to an external system to compensate an account associated with the user, the compensation is logged in a blockchain, etc.

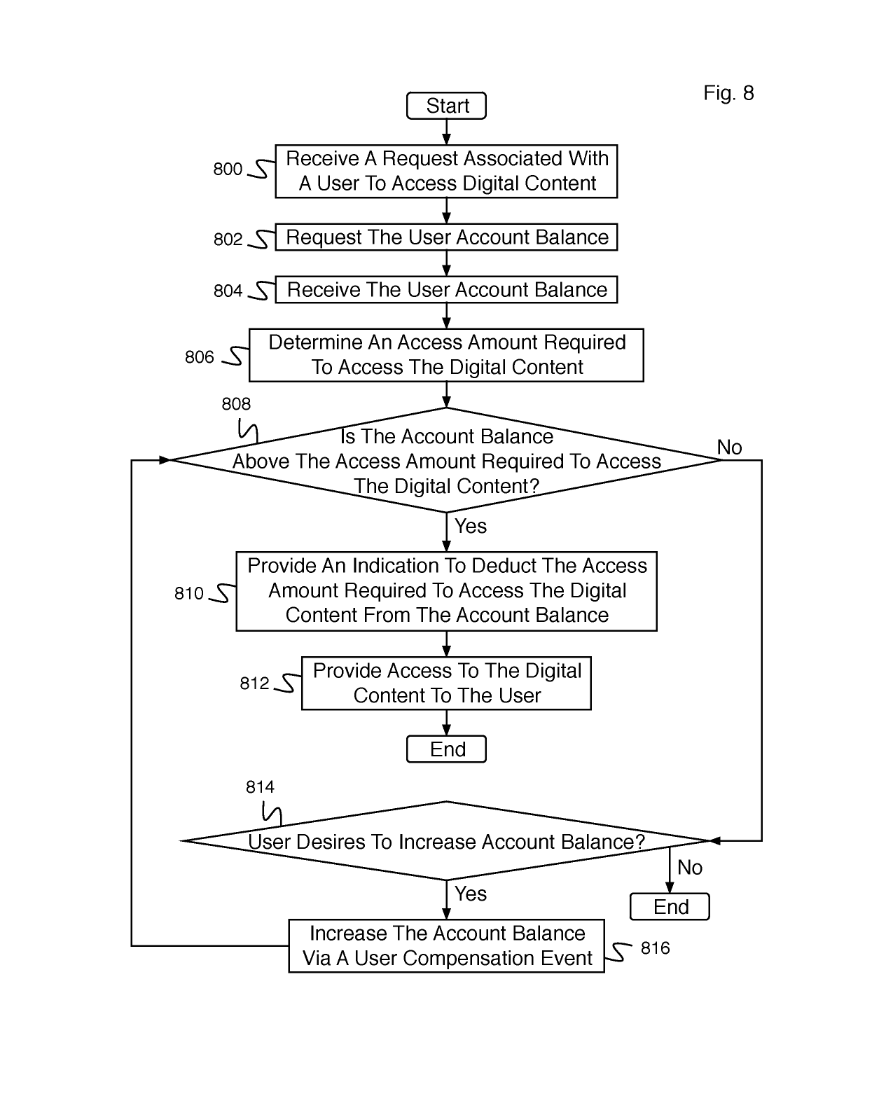

FIG. 5B is a flow diagram illustrating an embodiment of a process for storing a transaction in an account. In some embodiments, the process of FIG. 5B is used to store a compensation amount for an account as indicated in 510 of FIG. 5B. In some embodiments, the process of FIG. 5B is used to store a deduction amount for an account as indicated in 810 of FIG. 8. In the example shown, in 520 aggregated data and index data are received. For example, aggregated transaction data is received from a source that aggregates transactions by user up to a specified amount, by transaction up to a specified number, by segment of users, subscribers, by non-subscribers, by content viewed, by premium content viewed, or any other appropriate aggregation strategy. In 522, aggregated data and index data are stored in local storage. For example, the index data is stored in an index and the aggregated data is stored while waiting confirmation of storage in a ledger. In some cases, in 524, aggregated data is aggregated and the index is updated. For example, aggregated data is further aggregated with other data received and stored in local storage. Note that the index is updated with the ledger storage information so that a given transaction or other data can be located within the ledger. The status for storage is also stored in the index so that in the event that the system fails, it can be determined by examining the index whether the aggregated was stored in the ledger or was not stored in the ledger or where the data is stored in the local storage so that it can be requeued for storage in the ledger. In 526, data is stored in ledger. For example, the aggregated data or the further aggregated data is stored in a ledger (e.g., a block chain) and, in some embodiments, distributed to be stored in a number of other ledgers. In 528, successful storage is indicated in the index for data stored in ledger. For example, a flag indicating successful storage for each transaction or other data that is stored in the ledger along with a locator within the ledger is stored in the index. In some embodiments, the locator comprises a block identifier or an data identifier for a specific piece or portion of data.

FIG. 5C is a flow diagram illustrating an embodiment of a process for reading a transaction in an account. In some embodiments, the process of FIG. 5C is used to implement the action required to respond to the request for a user account balance of 802 of FIG. 8. In the example shown, in 540 an indication is received to retrieve data. For example, an indication requesting a user account balance is received. In 542, data location is determined using the index. For example, data associated with a user account balance is located in the index and a unit location with the ledger is determined using the index data. In 544, a unit is retrieved from the ledger. For example, a unit storing the user account balance is retrieve from the ledger. In 546, data is extracted from the unit. For example, the data directly needed for the user account balance is extracted from the unit retrieved from the ledger. In 548, data is provided to the requestor. For example, the user account balance is provided to the system from which a request was sent.

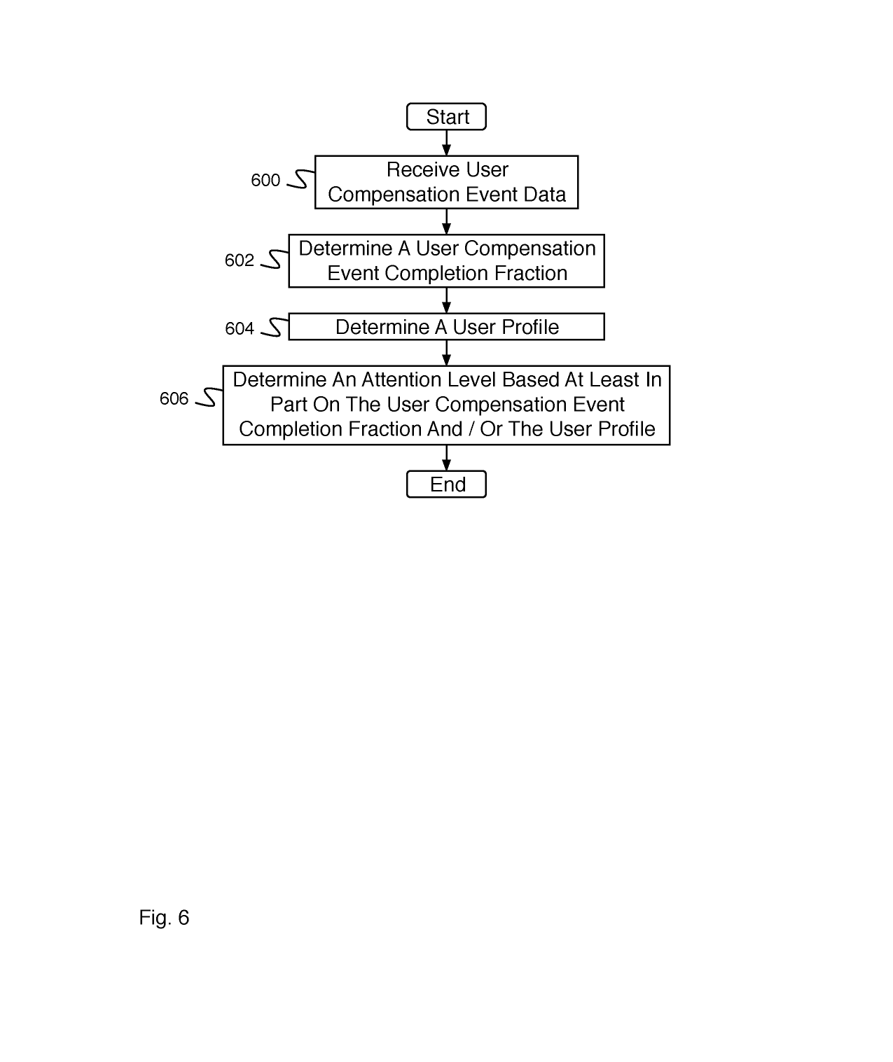

FIG. 6 is a flow diagram illustrating an embodiment of a process for determining an attention level associated with a user compensation event. In some embodiments, the process of FIG. 6 implements 506 of FIG. 5A. In the example shown, in 600, user compensation event data is received. For example, user compensation event data comprises stakeholder data, user compensation event time, user compensation event duration, user compensation event completion fraction, user compensation event start/stop data, etc. In 602, a user compensation event completion fraction is determined. In various embodiments, a user compensation event completion fraction comprises a fraction of a video that was watched, a time spent watching a video, a time spent playing a game, a time spent answering a survey, a user click result, an advertising conversion result, or a purchase amount purchased. In 604, a user history is determined. For example, the user profile comprises number of user compensation events today, typical number of user compensation events, user compensation event conversion ratio, user personal data, user gender, user income, user interests, user location, user education, user age, user political leanings, or historical user advertising engagement, etc. In 606, an attention level is determined based at least in part on the user compensation event completion time and/or the user profile. For example, the attention level comprises a normalized (e.g., on a scale of 0 to 1) estimate of the fraction of the user full attention that was put to the full user compensation event experience. In some embodiments, the attention level is based at least in part on a time of day.

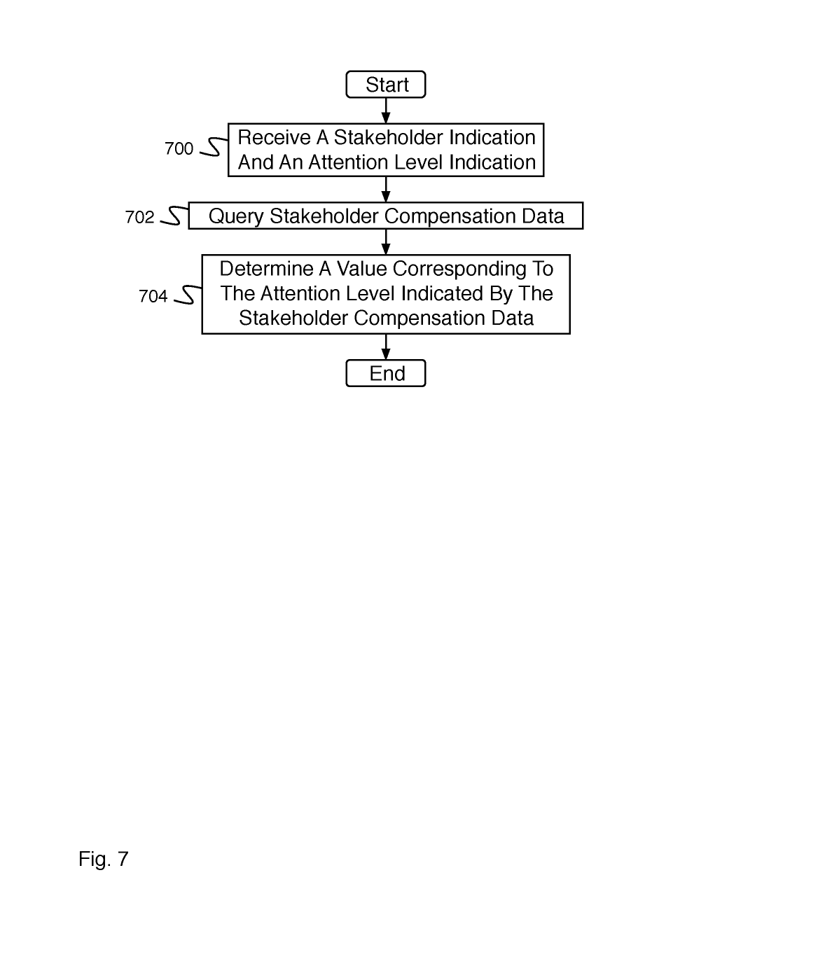

FIG. 7 is a flow diagram illustrating an embodiment of a process for determining a value for a user compensation event. In some embodiments, the process of FIG. 7 implements 508 of FIG. 5A. In the example shown, in 700, a stakeholder indication and an attention level indication are received. In 702, stakeholder compensation data is queried. In 704, a value corresponding to the attention level indicated by the stakeholder compensation data is determined. For example, the value corresponding to the attention level is determined based at least in part on an auction or on advertisers (e.g., a bidding from advertisers, a setting of value by advertisers, etc.) or any other appropriate factor.

FIG. 8 is a flow diagram illustrating an embodiment of a process for accessing content. In some embodiments, the process of FIG. 8 is executed by account compensation system 104 of FIG. 1. In the example shown, in 800, a request associated with a user to access digital content is received. For example, digital content comprises news content, blog content, image content, webpage content, video content, games content, digital goods content, or content with a publisher. In 802, the user account balance is requested. In 804, the user account balance is received. In 806, an access amount required to access the digital content is determined. In some embodiments, the access amount required to access the digital content is determined by communicating with a content provider or querying stored access amount information. In 808, it is determined whether the account balance is above the access amount required to access the digital content from the account balance. In the event it is determined that the account balance is not above the access amount required to access the digital content, control passes to 814. In the event it is determined that the account balance is above the access amount required to access the digital content, control passes to 810. In 810, an indication is provided to deduct the access amount required to access the digital content from the account balance. In 812, access to the digital content is provided to the user, and the process ends. For example, a token is provided directly (or indirectly via a user system) to a content provider from an account server. In some embodiments, the token stores a value, which may appreciate or depreciate over time. In some embodiments, tokens are distributed to all participating users, brands, and publishers and exchanged for verification or for identification or for transactions. In 814, it is determined whether the user desires to increase the account balance. For, the user is prompted for an indication of whether the user desires to increase the account balance, a stored user preference is consulted for a determination of whether the user desires to increase the account balance, a determination is made based on user history, time of day, user mood, etc. In the event it is determined that the user does not desire to increase the account balance, the process ends. For example, an indication is provided to the user that access is not allowed. In the event it is determined that the user desires to increase the account balance, control passes to 816. In 816, the account balance is increased via a user compensation event. Control then passes to 808.

In some embodiments, in response to determining that the account balance is not above the access amount required to access the digital content, a credit system is accessed that provides a user additional balance to access the digital content immediately and repay the additional balance at a later time. For example, in the case where a user consumes content throughout the day but is only willing or able to consume advertising in the evenings after work and the user spends through their account balance in the morning and has insufficient funds for mid-day content consumption, credit is extended enabling the user to access the content and repay the balance at a later time. In some embodiments, a user has a credit score (e.g., based on identity, identity certainty, behavior consistency, etc.) that indicates a credit worthiness for a loan of the funds required for access of digital content.

In various embodiments, a user identity is determined based on a login, use of an identity token, a pattern of usage, a pattern of access, or any other appropriate manner of determining identity.

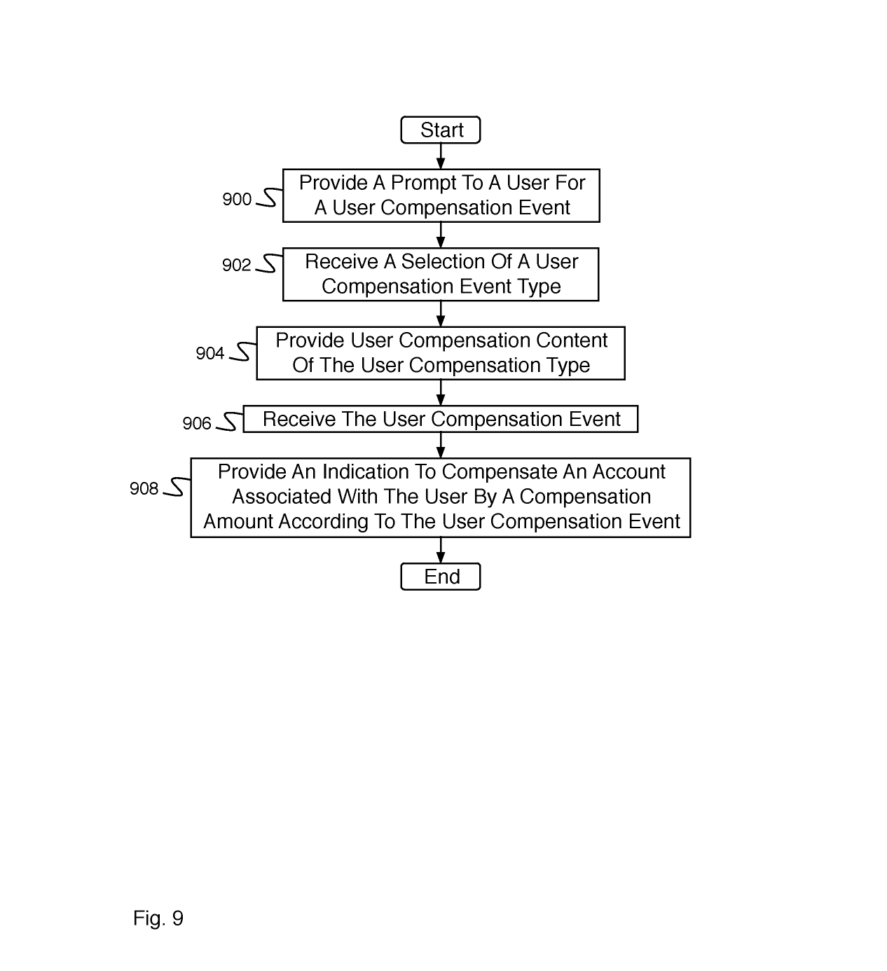

FIG. 9 is a flow diagram illustrating an embodiment of a process for increasing the account balance via a user compensation event. In some embodiments, the process of FIG. 9 implements 816 of FIG. 8. In the example shown, in 900, a prompt is provided to a user for a user compensation event. For example, the prompt comprises a prompt to watch an advertisement, a prompt for personal information, a prompt to fill out a survey, or a prompt for payment. In 902, a selection of a user compensation event type is received. In some embodiments, a selection of a user compensation event type comprises an indication that the user does not want to perform a user compensation event, and the process ends. In the event that the selection of the user compensation event type does not comprise an indication that the user does not want to perform a user compensation event, the process continues. In 904 user compensation content of the user compensation type (e.g., an advertisement) is provided. In 906, the user compensation event (e.g., an indication that the advertisement was watched) is received. In 908, an indication to compensate an account associated with the user by a compensation amount according to the user compensation event is provided. In the example shown, compensation to the account is provided immediately.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for providing account compensation, comprising:
an interface configured to:
receive a set of activity events associated with a user; and
a processor configured to:
determine a user compensation event from the set of activity events;
determine a stakeholder associated with the user compensation event;
determine an attention level associated with the user compensation event;
determine a value for the user compensation event based at least in part on the stakeholder and the attention level; and
provide an indication to compensate an account associated with the user by a compensation amount corresponding to the value.

2. The system of claim 1, wherein the user compensation event comprises watching an online advertisement, imaging a QR code, entering a geofence region, answering questions in a survey, providing personal information, or providing payment.

3. The system of claim 2, wherein the QR code is displayed during a movie, on television, on printed advertising, or on a vehicle.

4. The system of claim 1, wherein the attention level associated with the user compensation event is based at least in part on a fraction of a video that was watched, a time spent watching a video, a time spent playing a game, a time spent answering a survey, a user click result, an advertising conversion result, or a purchase amount purchased.

5. The system of claim 1, wherein activity events associated with the user are received at a predetermined interval.

6. The system of claim 1, wherein the stakeholder comprises a brand owner or an advertiser.

7. The system of claim 1, wherein determining the value for the user compensation event comprises querying stakeholder compensation data.

8. The system of claim 1, wherein the value for the user compensation event is based at least in part on a user profile or on a time of day.

9. The system of claim 8, wherein the user profile comprises number of user compensation events today, typical number of user compensation events, user compensation event conversion ratio, user gender, user income, user interests, user location, user education, user age, user political leanings, or historical user advertising engagement.

10. The system of claim 1, wherein compensating the account associated with the user by the compensation amount comprises logging the compensation in a blockchain.

11. The system of claim 1, wherein the processor is further configured to:
receive a request associated with the user to access digital content;
request a user account balance;
receive the user account balance;
determine whether the user account balance is above an access amount required to access the digital content; and
in response to a positive determination that the user account balance is above the access amount required to access the digital content:
provide an indication to deduct the access amount required to access the digital content from the account balance; and
provide access to the digital content to the user.

12. The system of claim 11, wherein the processor is further configured to:
in response to a negative determination that the account balance is not above the access amount required to access the digital content:
provide a prompt to the user for the user compensation event.

13. The system of claim 12, wherein, in response to the user compensation event, compensation to the account associated with the user is provided immediately.

14. The system of claim 12, wherein, in response to the user compensation event, access to the digital content is provided to the user, and an indication is provided to deduct the access amount required to access the digital content from the account balance.

15. The system of claim 12, wherein the prompt for the user compensation event comprises a prompt to watch an advertisement, a prompt for personal information, a prompt to fill out a survey, or a prompt for payment.

16. The system of claim 11, wherein the content comprises news content, blog content, image content, webpage content, video content, games content, digital goods content, or content with a publisher.

17. The system of claim 11, wherein the processor is further configured to determine the s access amount required to access the digital content.

18. A method for providing account compensation, comprising:
receiving a set of activity events associated with a user;
determining, using a processor, a user compensation event of the set of activity events;
determining a stakeholder associated with the user compensation event;
determining an attention level associated with the user compensation event;
determining a value for the user compensation event based at least in part on the stakeholder and the attention level; and
providing an indication to compensate an account associated with the user by a compensation amount corresponding to the value.

19. A computer program product for providing account compensation, the computer program product being embodied in a non-transitory computer readable storage medium and comprising computer instructions for:
receiving a set of activity events associated with a user;
determining a user compensation event of the set of activity events;
determining a stakeholder associated with the user compensation event;
determining an attention level associated with the user compensation event;
determining a value for the user compensation event based at least in part on the stakeholder and the attention level; and
providing an indication to compensate an account associated with the user by a compensation amount corresponding to the value.
